(19) United States
(12) Patent Application Publication
(10) Pub. No.: US 2005/0240676 A1
(43) Pub. Date: Oct. 27, 2005

(54) Method for playing multimedia data and a system of enabling the method

(75) Inventor: Eui Sun Moon, Seoul (KR)

Correspondence Address: BACON & THOMAS, PLLC, 625 SLATERS LANE, FOURTH FLOOR, ALEXANDRIA, VA, 22314, US

(73) Assignee: PEERING PORTAL INC., Seoul (KR)

(21) Appl. No.: 10/508,696

(22) PCT Filed: Jan. 28, 2003
(86) PCT No.: PCT/KR03/00186

§ 371 Date: Sep. 29, 2004

(30) Foreign Application Priority Data
Mar. 29, 2002 (KR) 10 2002 017394

(51) Int. Cl. G06F 15/16

(52) U.S. Cl. 709/231

(57) ABSTRACT

The present invention relates to a method for playing multimedia data and a system of enabling the method, and more particularly, to a method for playing multimedia data and a system of enabling the method, wherein streaming data are generated from received multimedia data and then played regardless of whether the multimedia data are transmitted in accordance with a streaming method. The method for playing the multimedia data according to the present invention comprises the steps of receiving play instructions from a player program, requesting the multimedia data in response to the play instructions, receiving and storing the multimedia data by using a protocol, generating streaming data by using the stored multimedia data, and causing the streaming data to be provided to and played by the player program.

### TECHNICAL FIELD

The present invention relates to a method for playing multimedia data and a system of enabling the method, and more particularly, to a method for playing multimedia data and a system of enabling the method, wherein streaming data are generated from received multimedia data and then played regardless of whether the multimedia data are transmitted in accordance with a streaming method.

### BACKGROUND ART

The Internet has provided a chance of substantially converting an information acquisition route. Nowadays, all kinds of information available in an offline state can also be searched through the Internet. Search of information using the Internet functions as an important information acquisition route since it has advantages of quickness and convenience. In addition to the Internet, one of major factors of improvement in information grapevine is the World Wide Web. With the use of the World Wide Web, users can easily and quickly search desired information through a convenient and intuitive interface.

In the past, a large volume of data cannot be stored and quickly transmitted due to insufficient computer and communications technologies. Thus, information spread through the Internet at the early period was mainly text data with small volumes. However, as limitations on the computer and communications technologies have been overcome, multimedia data such as videos or audios have been gradually increased in information spread through the Internet.

The multimedia data such as videos or audios are generally larger than the text data in volume. Since it takes much time to transmit a large volume of data through the Internet as compared with transmission of a small volume of data therethrough, it takes much time to transmit the multimedia data as compared with the transmission of the text data. Accordingly, there is a need for a new method for transmitting the multimedia data through the Internet and playing the received multimedia data.

A most general method for transmitting information through the Internet is a download method. This method has been widely used from when information comprising texts was mainly transmitted in the past, wherein a user received entire data searched through the Internet and stored them in his/her computer so as to use them later. The download method can also be applied to the multimedia data In practice, there is no choice but to use the download method in case of providing data in a file format such as an AVI or DIVX format, which cannot support the streaming method and will be described later, without using the streaming method. However, in such a case, the multimedia data can be played only after the entire data have been completely received. Thus, the user should wait for a long time until the data will be completely received.

Further, since the multimedia data can be played only after the entire data have been completely received in accordance with the method of the prior art, the method of the prior art cannot be used in a case where the user intends to play only a portion of the entire multimedia data or to determine whether he/she receive the entire data after play of only a portion of the multimedia data.

Meanwhile, in addition to the large volume over the other data, another feature of the multimedia data is that they are sequentially and regularly retrieved and then played. That is, upon play of audios or videos using the multimedia data, the data are played in predetermined order with time, and there is no problem in use of multimedia by the user if data corresponding to a portion to be played exist. With such a feature, it is not necessary that an entire data file should be stored in order to drive the multimedia data. That is, entire multimedia data should not necessarily exist in order to play the large volume of multimedia data corresponding to a video with a running time of one hour. The video can be played if there are only multimedia data corresponding to a portion that is being played.

In order to solve the problems in the aforementioned download method, the streaming method has been devised for transmission and play of the multimedia data in consideration of the features of the play of the multimedia data. According to the streaming method, in a case where the user intends to play the multimedia data received through a communication network, receipt of the multimedia data from a server is started and play of the received multimedia data is started after the received data are stored in a buffer with a predetermined size. During the play thereof, the multimedia data are received from the server in real time in synchronous with a play rate of the multimedia data so that the play cannot be stopped.

The technical definition of the streaming is as follows:

“Streaming is a technique for transmitting processed data in a regular and continuous flow, and with the use of the streaming, an application program for processing data can drive data before a desired entire data file is completely transmitted.”

Methods for implementing streaming services can be generally divided into an on-demand streaming method and a broadcast streaming method. In the on-demand streaming method, a user on the side of a client terminal can perform operations such as start and stop of play of multimedia data, and play of multimedia data from any piece of data thereof (i.e., change in a position of play), so that the user can control the play of the streaming data. On the other hand, in the broadcast streaming method, the user is passive for flow of data transmitted simply in the streaming method (hereinafter, referred to as “streaming data”), and thus, the user can listen to (or view) the streaming data transmitted through a communication network as soon as they are received but cannot again listen to (or view) pieces of the streaming data that have already passed. Further, the streaming data cannot also be played from any piece of data thereof. Therefore, the broadcast streaming method can be referred to as unilateral play of the multimedia data that is a general broadcast scheme.

As described above, when using the streaming services, the user does not have to wait for transmission of the entire data, and particularly in case of the on-demand streaming method, can freely perform start of play, change in a position of play and the like in the same manner as play of the data after receipt of the entire data.

Further, in case of the streaming services, the multimedia data are not stored in the client terminal. Thus, it is possible to prevent the multimedia data from draining out (circulation of the multimedia data without agreement or permission of a rightful person such as an author).

Although such streaming methods have many advantages over the prior art, there are still problems to be solved.

The streaming methods receive only desired pieces of the multimedia data in real time in a state where the entire multimedia data are not stored, contrary to the download method. Thus, the streaming methods are sensitive to a data transmission rate. If the data transmission rate is high, there is no problem in that the client terminal stores surplus pieces of data in the buffer and then plays the data if necessary. However, if the data transmission rate is lower than that required for the play, expression of data may not be smooth and thus sounds may be distorted or pictures may temporarily pause. When data are transmitted after a wait for the transmission of the data, the data may be played again.

Further, in a case where a plurality of client terminals connect with a server for providing the streaming data and simultaneously intend to receive the streaming data, the data transmission rate is lowered as the number of client terminals is increased, and thus, the multimedia data cannot be smoothly played. Accordingly, the advantage of the streaming method that the multimedia data are transmitted and simultaneously played is cancelled out. For example, if n client terminals connect with the server and intend to receive encoded data at a data transmission rate of 250 kbps, a required line becomes (250×n) kbps. That is, there is a problem in that the server for providing the streaming service needs a transmission line with a high capacity.

Further, since the multimedia data are not stored in the client terminals in the streaming methods for transmitting data in real time, the same multimedia data should be received again from the server in order to repeatedly play pieces of data that have been already played. Thus, an unnecessary load is produced.

### DETAILED DESCRIPTION OF INVENTION

The present invention is conceived to solve the problems in the prior art. An object of the present invention is to provide a method for playing multimedia data and a system of enabling the method, wherein even in a case where the multimedia data are not received in accordance with a streaming method, desired pieces of the multimedia data to be played can be played when the pieces of the multimedia data have been transmitted in a state where the entire multimedia data to be played are not received (streaming service).

Another object of the present invention is to provide a method for playing multimedia data and a system of enabling the method, wherein stored pieces of the multimedia data among the transmitted multimedia data are found out, and then, the stored pieces of the multimedia data can be played without again receiving the stored pieces of the multimedia data (storage of multimedia data).

A further object of the present invention is to provide a method for playing multimedia data and a system of enabling the method, wherein in order to prevent the multimedia data stored in computers from being played without agreement or permission of a rightful person, the multimedia data are encrypted and stored and then decrypted to be played (prevention of duplication).

A still further object of the present invention is to provide a method for playing multimedia data and a system of enabling the method, wherein desired pieces of the multimedia data are predicted and then beforehand received based on play order of the multimedia data so as to prevent the quality of play from being deteriorated depending on a data transmission rate (predicted transmission).

A still further object of the present invention is to provide a method for playing multimedia data and a system of enabling the method, wherein while a streaming service is provided, the multimedia data can be received in parallel from a plurality of data provider including a server as well as the server so as to increase the data transmission rate and to ensure real-time play of the data (parallel transmission).

In order to achieve the objects and solve the problems in the prior art, a method for playing multimedia data according to one aspect of the present invention comprises the steps of receiving play instructions from a player program; requesting the multimedia data in response to the play instructions; receiving and storing the multimedia data by using a protocol; generating streaming data by using the stored multimedia data; and causing the streaming data to be provided to and played by the player program.

The multimedia data may be divided into segments composing the multimedia data, and the steps may be performed on a segment basis. The segment is defined herein as a logical unit with a fixed or varying size for composing the multimedia data.

The multimedia data playing method may further comprise the step of, if the multimedia data are previously stored in the client computer, generating the streaming data from the stored multimedia data in response to the play instructions.

The protocol may be a protocol except a streaming protocol.

Moreover, a method for playing multimedia data according to another aspect of the present invention comprises the steps of receiving play instructions from a player program; receiving a plurality of segments composing the multimedia data from a plurality of information processors with the respective segments stored therein and storing the received segments, in response to the play instructions; generating streaming data from the stored segments; and causing the streaming data to be provided to and played by the player program.

The multimedia data playing method may further comprise the step of reading segment identifiers of the segments, wherein the step of generating the streaming data from the stored segments is performed using the segment identifiers.

The step of receiving the plurality of segments from the plurality of information processors with the segments stored therein and storing the received segments may comprise the steps of receiving position information on the plurality of information processors with the respective segments stored therein from a predetermined server; and receiving in parallel and storing the plurality of segments from the plurality of information processors based on the position information.

In addition, the multimedia data playing method may further comprise the steps of encrypting the received multimedia data or segments before they are stored; and decrypting the encrypted multimedia data or segments before the streaming data are generated.

According to a further aspect of the present invention, there is provided a computer-readable recording medium in which a program for performing any one of the aforementioned multimedia data playing methods is recorded.

A system for playing multimedia data according to a still further aspect of the present invention comprises a transmitter module for transmitting multimedia data requesting instructions for requesting the multimedia data when play instructions are input from a player program; a receiver module for receiving multimedia data corresponding to the multimedia data requesting instructions from a server or other client computers by using a protocol; a storage module for storing the multimedia data therein; and a streaming data generator module for generating streaming data by using the stored multimedia data and providing the streaming data to the player program.

The streaming data generator module may comprise a segment identifier reading means for reading segment identifiers of the segments to generate the streaming data based on the segment identifiers.

The storage module may include an encryption means for encrypting and storing the segments, and the streaming data generator module includes (may include?) a decryption means for decrypting the encrypted segments.

Moreover, in the multimedia data playing method and system according to the present invention, the play instructions may include play position changing instructions for changing a position of a currently played segment and causing a segment at the changed position to be played.

According to the multimedia data playing method and system of the present invention, even in a case where the multimedia data are received from a sever that does not provide a streaming service, there is a technical advantage in that the streaming service can be provided by the client computer. Since multimedia data in an AVI or DIVX format have no sequence in their physical recordation fashions, a streaming transmission module (i.e., streaming server) should always be provided in the server to sequentially transmit the multimedia data in order to provide the streaming service. However, in the present invention, the streaming data are generated from the multimedia data in the client computer and then provided to the player program differently than the information processor sequentially transmits the multimedia data. As a result, an arbitrary general protocol, which can be easily implemented, other than a streaming protocol can be employed for streaming transmission between the server and the client computer.

Furthermore, according to the multimedia data playing method and system of the present invention, since the multimedia data are received in parallel from the plurality of information processors based on the position information stored in the server, there is a technical advantage in that time duration required for transmission of the multimedia data is reduced.

Moreover, according to the multimedia data playing method and system of the present invention, since the multimedia data (or segments) necessary for play are predicted and beforehand received in accordance with play order, there is a technical advantage in that smooth play can be achieved.

In addition, according to the multimedia data playing method and system of the present invention, since some of the received multimedia data are stored in the client computer and upon repeated play of multimedia data, the stored multimedia data need not be received again based on determination of whether multimedia data to be played are the already stored multimedia data, there is a technical advantage in that loads on the server and the client computer can be reduced. Meanwhile, the present invention is similar to the download method in that the multimedia data are stored in the client computer in which the multimedia data are played. However, in the download method, arbitrary duplication and play may be made since the multimedia data exist in a file format that can be arbitrarily duplicated by users. On the contrary, since the present invention employs the encryption and decryption, the multimedia data can be played only in the client computer that has received the multimedia data.

### BRIEF DESCRIPTION OF DRAWINGS

FIG. 1 is a view showing a configuration of a network for providing a method for playing multimedia data according to an embodiment of the present invention;

FIG. 2 is a flowchart illustrating the method for playing the multimedia data according to the embodiment of the present invention;

FIG. 3 is a view showing a configuration of a network for providing a method for playing multimedia data according to another embodiment of the present invention;

FIGS. 4a and 4b are flowcharts illustrating the method for playing the multimedia data according to the another embodiment of the present invention;

FIG. 5 is a view explaining the step of receiving the multimedia data in accordance with the method for playing the multimedia data according to the another embodiment of the present invention;

FIG. 6 is a block diagram showing a system for playing multimedia data according to a further embodiment of the present invention;

FIG. 7 is a block diagram showing a system for playing multimedia data according to a still further embodiment of the present invention;

FIG. 8 is a view explaining an encryption means and a decryption means for use in the system for playing the multimedia data according to the still further embodiment of the present invention; and

FIG. 9 is a view explaining a universal computer capable of being used for playing the multimedia data according to the present invention.

<Explanation of Reference Numerals for Designating Main Components in the Drawings>
11, 31, 730: Server
12, 32, 600, 700: Client computer
630, 740, 750: Information processor
611: Receiver module
612: Transmitter module
711: First transceiver module
712: Second transceiver module
613, 713, 812, 822: Storage module
614, 714, 813, 823: Streaming data generator module
620, 720: Player program
631: Information processor-side transceiver module
632: Information processor-side storage module
731: Server-side transceiver module
732: Server-side segment storage module
733: Position information storage module

### DETAILED DESCRIPTION OF THE PREFERRED EMBODIMENT

Hereinafter, preferred embodiments of the present invention will be described in detail with reference to the accompanying drawings.

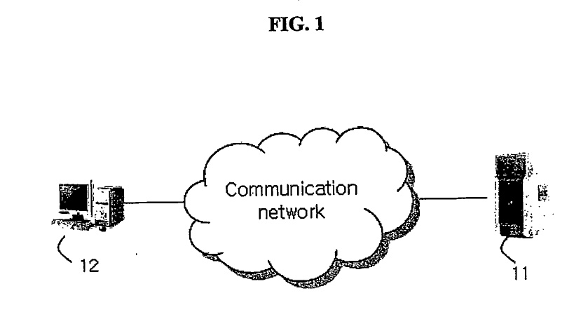

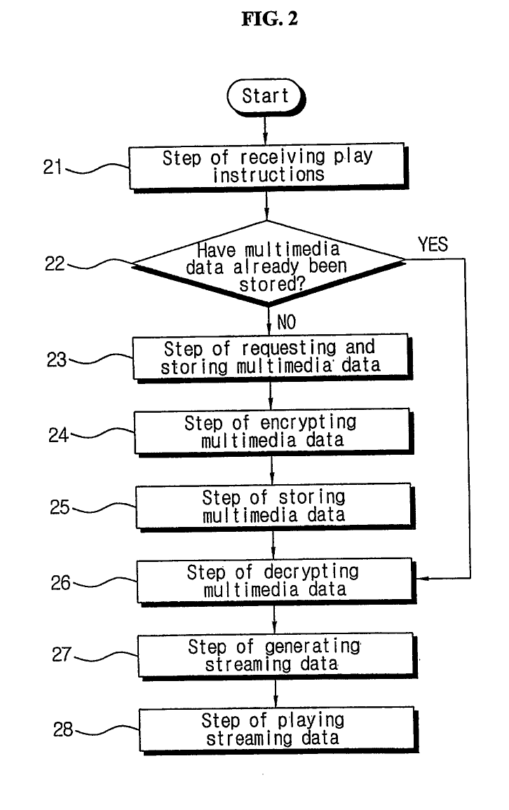

Referring to FIGS. 1 and 2, a method for playing multimedia data 20 according to a first embodiment of the present invention will be explained. FIG. 1 is a view showing a configuration of a network for providing the multimedia data playing method 20, and FIG. 2 is a flowchart illustrating the multimedia data playing method 20.

The multimedia data playing method 20 comprises the steps of receiving play instructions (step 21), requesting and receiving multimedia data (step 23), encrypting the multimedia data (step 24), storing the multimedia data (step 25), decrypting the multimedia data (step 26), generating streaming data (step 27), and playing the streaming data (step 28).

In step 21, the play instructions are input from a player program of a client computer 12. The player program may be a conventional player program such as the Microsoft Windows Media Player or Real Player. In step 22, it is determined whether the multimedia data to be played have been stored in the client computer 12, in response to the play instructions. If the multimedia data have been stored in the client computer 12, streaming data are generated from the multimedia data in step 27. According to another embodiment of the present invention, in step 22, it is determined whether the client computer 12 is receiving the multimedia data in addition to whether the multimedia data to be played have been stored in the client computer 12. If the client computer 12 is receiving them, the streaming data may be played when the multimedia data are completely received.

If the multimedia data have not been stored in the client computer 12, the multimedia data are requested and received in step 23. The step of requesting the multimedia data may include the step of requesting the multimedia data to a server 11 or the other client computers that have the multimedia data stored therein and are connected through the network to the client computer 12 on which the player program is running. That is, the multimedia data can be received from the client computers in addition to the server (hereinafter, for the sake of convenience of description, the server or client computer for providing the multimedia data is referred to as “information processor”).

In step 23, the multimedia data may be requested and received by using an arbitrary protocol. Since the multimedia data playing method according to the embodiment of the present invention is primarily characterized in that the client computer 12 generates the streaming data, the multimedia data can be received by using an arbitrary protocol in addition to a streaming protocol even in a case where a multimedia data providing side (e.g., server 11) does not transmit the multimedia data in accordance with a streaming method. Since an arbitrary protocol can be used, the present invention can also be applied to the case where the multimedia data are received using the streaming protocol. If the server provides the streaming service, a net profit of the streaming service provided in the embodiment of the present invention may be decreased. However, as described later, the multimedia data playing method 20 according to the embodiment of the present invention has other advantages over the conventional streaming service in that since the multimedia data have been stored in the client computer 12, pieces of the multimedia data that have been already stored need not be received again in case of repeated play. The multimedia data can be received regardless of play order of pieces of the multimedia data and can also be sequentially received based on the play order so as to facilitate generation of the streaming data.

In step 24, the received multimedia data are encrypted. Even though the multimedia data are not encrypted, it dose not have an effect on the streaming service in which the client computer 12 generates the streaming data and provides them to the player program. However, in the multimedia data playing method 20 according to the embodiment of the present invention, the multimedia data are stored in the client computer 12 contrary to the case where they are originally received from the server 11 in accordance with the streaming method. Therefore, there is a possibility that the multimedia data stored in the client computer 12 will be drain out without agreement or permission of a rightful person such as an author. Accordingly, there is a need for prevention of the possibility. Further, in addition to the case where the multimedia data are drained out, a case where an allowed term of use expires after the multimedia data are received and stored, a program that is not allowed to use the multimedia data (e.g., a program for duplicating or extracting the multimedia data) intends to gain access to the multimedia data, or the like is considered as a use without the agreement or permission. Thus, there is a need for prevention of occurrence of such a case. Accordingly, such risks can be avoided by the steps of encrypting and storing the received multimedia data, decrypting the encrypted multimedia data and generating the streaming data, as described later.

In step 25, the encrypted multimedia data are stored.

In step 26, the encrypted multimedia data are decrypted. In step 27, the streaming data are generated using the decrypted multimedia data. If the encrypted multimedia data are duplicated without agreement of the rightful person, the multimedia data may be caused not to be played. Such encryption may be made in such a manner that only a streaming data generator module residing in an allowed client module is set to read the multimedia data upon storage of the multimedia data so that the multimedia data are not allowed to be played when they are duplicated to other client computers. Since encryption and decryption methods depart from the scope of the present invention and significantly need to be confidential, the detailed description thereof will be omitted herein. According to a further embodiment of the present invention, as for the encryption and decryption methods, encryption and decryption methods using conventionally known algorithms may be employed.

In step 28, the streaming data are provided to the player program which in turn plays the streaming data. At this time, the amount of streaming data initially stored before start of play thereof may be set such that when the streaming data are generated beyond a predetermined size, they begin to be provided to the player program. This is to ensure sufficient pieces of streaming data to be played at the beginning, and accordingly, to prevent a wait for generation of pieces of streaming data to be subsequently played after pause of the play. On the other hand, if the amount of streaming data that will be initially stored is set to be very large, an initial buffering time is increased and thus user's wait before play of the streaming data after input of play instructions is also increased. Accordingly, it is not preferred that the amount of streaming data that will be initially stored be set to be very large.

With the aforementioned procedure, even in a case where the multimedia data are not received from the server (or other information processors) in accordance with the streaming method, the multimedia data received from a predetermined module of the client computer 12 can be generated into the streaming data in accordance with the streaming method. Thus, the player program in the client computer 12 can play the multimedia data in the same manner as the case where the multimedia data are received in accordance with the streaming method.

According to a still further embodiment of the present invention, the multimedia data may comprise segments. According to a still further embodiment of the present invention, the multimedia data playing method further comprises the step of reading ‘segment identifiers’ of stored segments, and the streaming data can be generated based on the segment identifiers in step 27. The segment is a logical unit with a fixed or varying size for composing the multimedia data, and the segment identifier can be implemented in various ways such as an offset or ID assigned to each segment.

In such a case where the multimedia data comprise the segments and the streaming data are generated by reading the segment identifiers, the multimedia data playing method according to the embodiment of the present invention can provide the on-demand streaming service in addition to the broadcast streaming service. The play instructions received by the player program may include play position changing instructions for changing a position of a currently played segment and causing a segment at a different position to be played. When the play position changing instructions are input, the position of the segment corresponding to the changed position can be determined from a segment identifier of the segment. Thus, the multimedia data can be played from the corresponding segment.

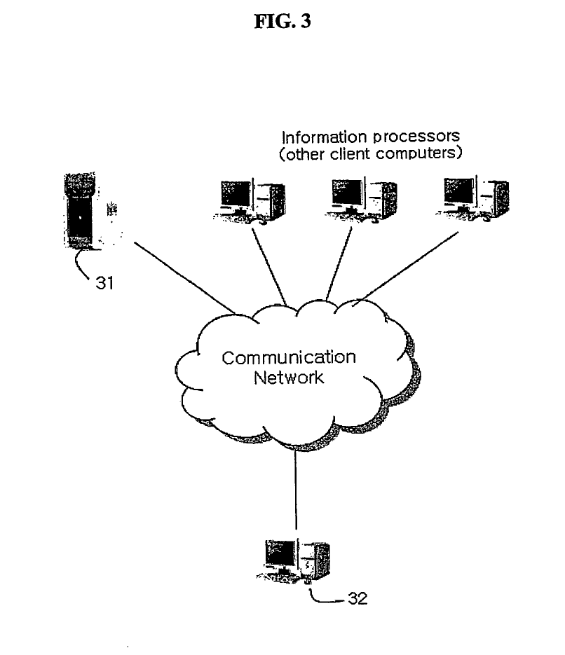

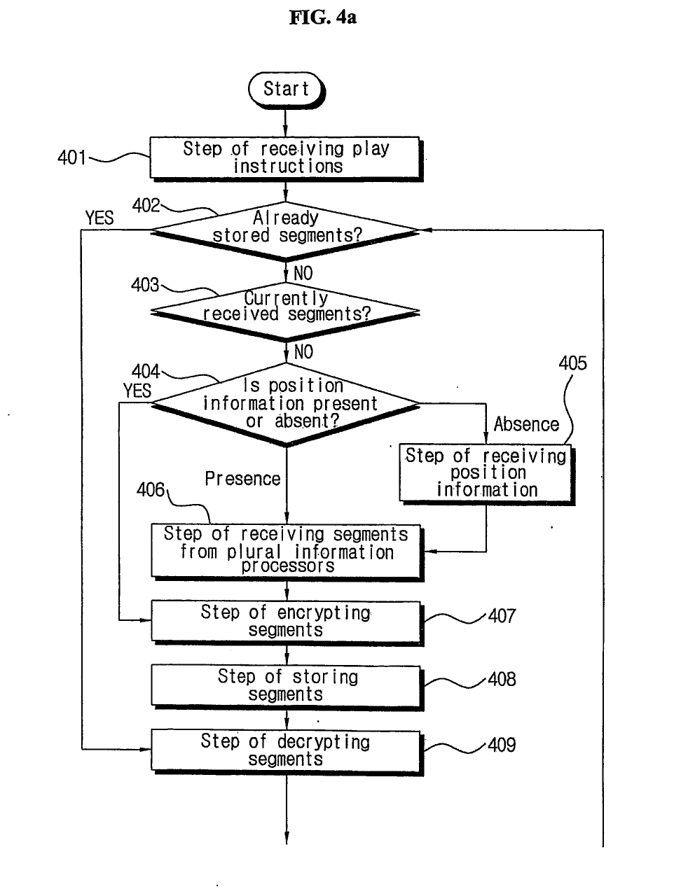

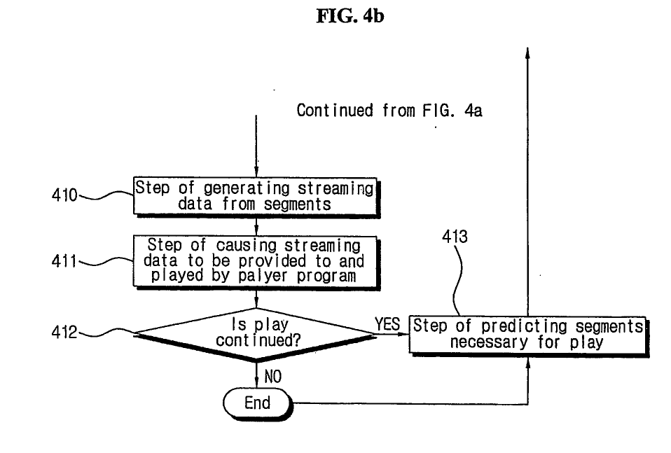

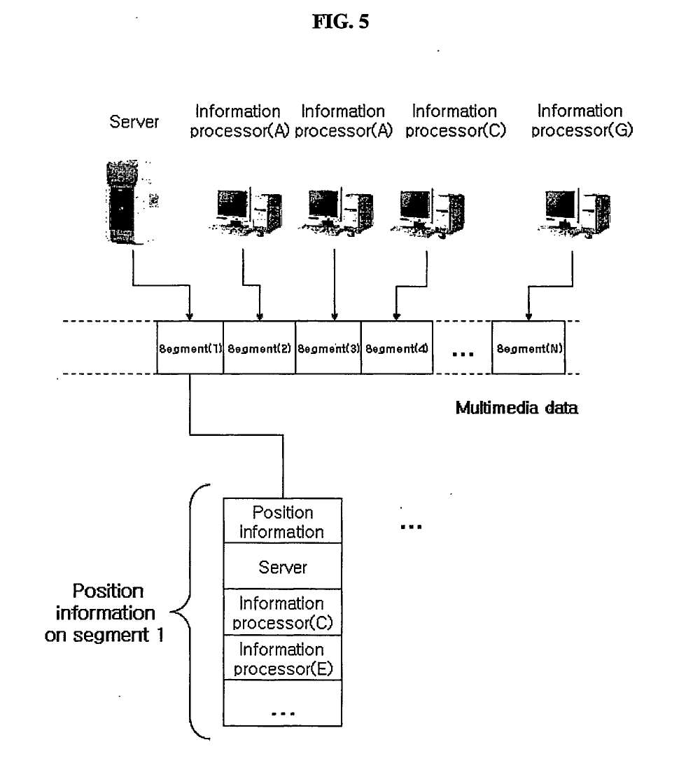

Referring to FIGS. 3 to 5, a method for playing multimedia data 400 according to a second embodiment of the present invention will be explained. FIG. 3 is a view showing a configuration of a network for providing the multimedia data playing method 400 according to the embodiment of the present invention, FIGS. 4a and 4b are flowcharts illustrating the multimedia data playing method 400, FIG. 5 is a view explaining the step of receiving the multimedia data in accordance with the multimedia data playing method 400.

The multimedia data playing method 400 comprises steps of receiving play instructions (step 401), requesting position information (step 405), receiving segments from a plurality of information processors (step 406), encrypting the segments (step 407), storing the segments (step 408), decrypting the segments (step 409), generating streaming data from the segments (step 410), providing the streaming data to a player program and causing the streaming data to be played (step 411), and predicting a segment necessary for the play (step 413).

The multimedia data playing method 400 according to the embodiment of the present invention handles the multimedia data on a segment basis and is different from the multimedia data playing method 20 according to the first embodiment of the present invention in that the segments of the multimedia data are received in parallel on a segment basis from the plurality of information processor rather than a single server or information processor.

In step 401, the play instructions are input from a player program of a client computer 32. Even in the present embodiment, in step 402, it is determined whether the segments of the multimedia data have been stored in the client computer, upon input of the play instructions, in the same manner as the first embodiment. If the segments have been stored therein, the procedure may proceed to step 409 in which the stored segments are decrypted. In step 403, it is determined whether the segments are being received. If the segments are being received, the procedure may proceed to step 407 when the segments are completely received. The received segments are then encrypted in step 407.

In a case other than the case where the segments have been stored or are being received, the segments will be received. The multimedia data playing method 400 is characterized in that the segments are received from the plurality of information processors. That is, the plurality of segments are received ‘in parallel’ from the plurality of information processors and the streaming data are generated by using the received segments. Thus, it is possible to reduce time required for receiving the multimedia data.

According to a still further embodiment of the present invention, in the case where the segments are received in parallel from the plurality of information processors, ‘position information’ that is information on positions of the information processors with the segments stored therein is utilized. To this end, in step 404, it is determined whether the position information has been already stored in the client computer 32. If the position information has not yet been stored therein, the position information is received from a server 31 for storing and managing the position information in step 405. Then, in step 406, the plurality of segments are received in parallel from the plurality of information processors based on the position information.

For example, assume that segments necessary for play are segment 1, segment 2 and segment 3 in play order thereof. Segments 1 to 3 are included in the multimedia data. If the parallel transmission is not used, segment 3 or 2 would be transmitted after segment 1 is completely transmitted (it is not necessary to transmit or receive the segments in play order even in the case where the parallel transmission is not used). However, if the segments are received in parallel from the plurality of information processors, one of segments 1 to 3 can be independently transmitted regardless of whether the other segments are completely transmitted.

That is, if the transmission is made from each of the information processors at a rate of 2 Mbps, an effect of transmission at a rate of 10 Mbps is obtained in a case where the transmission is made in parallel from five information processors. Such parallel transmission allows the transmission rate of the multimedia data to be stabilized. If the multimedia data are received from a single information processor, e.g., a single server, the transmission rate is irregular and unstable due to occurrence of a load resulting from other operations performed by the server. However, if the parallel transmission from the plurality of information processors is made, variance in the transmission rate is decreased as a whole and thus stable transmission can be ensured. Further, the parallel transmission results in a load balancing effect since an entire file is distributed and processed by the plurality of information processors rather than a single information processor in response to a request for the multimedia data. The reason why the parallel transmission can be made is that the multimedia data playing method according to the present invention is configured to provide the streaming service by generating the streaming data in the client computer using the segments stored therein rather than by receiving the streaming data from a predetermined server and thus it is not necessary to particularly receive the segments from the single information processor.

The position information is information on which information processors store the respective segments therein (since it is apparent that the client computer 32 can receive the segments from the server 31, the information processor is a concept including the server). The position information is prepared in various ways in accordance with embodiments. The ways of receiving the segments from the information processors may be slightly modified depending on the information preparing ways.

First, an embodiment in which the position information is information for describing information processors storing a predetermined segment therein will be explained. A case Where the multimedia data comprise segment 1, segment 2, segment 3, . . . , segment N will be explained by way of example. In this case, the position information may be prepared for respective segments 1, 2, . . . , N as follows:
[segment 1: server, information processor C, information processor E, . . . ]
[segment 2: information processor A, information processor B, information processor F, . . . ]
. . .
[segment N: information processor D, information processor G, information processor A,].

First, if segment 1 is intended to be received, it is possible to inquire about whether segment 1 exists, starting from information processor A until an information processor which responds that segment 1 actually exists therein is found out. The reason why the inquiry procedure is required is that although segment 1 was stored in information processor A, C, E, . . . at the time when the position information was stored in the server 31, there is a possibility that segment 1 has been deleted from information processor A or there is no response from information processor A when segment 1 is intended to be received by using the position information. FIG. 5 is a view explaining a case where segment 1 is received from the server among the information processors described in the position information if the position information on segment 1 is the same as described above.

At this time, the order of inquiring of the information processors described in the position information may be determined arbitrarily or the inquiries may be made in predetermined order based on assigned weight.

Then, an embodiment in which the position information is information for describing information processors storing segments of multimedia data therein will be explained. At this time, position information on information processors including any segments of the multimedia data rather than a specific segment is provided. A case where multimedia data MD1 comprises segment 1, segment 2, segment 3, . . . , segment N will be explained by way of example. In this case, the position information may be prepared as follows:
[multimedia data MD1: information processor C, information processor B, information processor F, information processor K, . . . ].

From the position information, it can be understood from the position information that information processor C stores a portion of the segments of multimedia data MD1, whereas it cannot be understood that a specific segment (e.g., segment 1) among the segments of multimedia data MD1 is stored in which information processor. Therefore, if segments 1 to 3 are intended to be transmitted in parallel, the inquiry is made first to information processor C about a segment stored therein. When it is confirmed that segment 2 is stored therein, segment 2 is received from information processor C. Then, when the inquiry is made to information processor B about a segment stored therein, and as a result, it is confirmed that segment 5 is stored therein, the inquiry is made to information processor F. When it is confirmed that information processor F stores segment 1 therein, segment 1 is received from information processor F. Since the process of receiving the segment from one of the respective information processors is a process performed independently from determination of whether the segment is completely transmitted from the other information processors, it will be apparent that the parallel transmission can be made even in such a case.

As described above, since the position information preparing ways may be modified depending on the embodiments even though the embodiments are the same in that the plurality of segments are received in parallel from the plurality of information processors, details of implementation algorithms may also be modified. However, the former way in which the position information is provided according to respective predetermined segments would have a high probability that a desired segment is stored in an information processor described in the position information.

According to a still further embodiment of the present invention, the multimedia data playing method further comprises the step of encrypting the segments, which have been received in parallel from the plurality of information processors, before storage of the received segments (step 407). As described in connection with the first embodiment, it is possible to prevent the multimedia data from being duplicated or distributed without agreement or permission of a rightful person by encrypting the segments. The encrypted segments should be decrypted in step 409 before they are generated into the streaming data in step 410.

In step 410, the streaming data are generated from the decrypted segments. According to a still further embodiment of the present invention, the multimedia data playing method further comprises the step of reading the segment identifiers of the segments, and step 410 can be performed using the segment identifiers. The discrimination of the respective segments into segment 1, segment 2 and the like in the previous embodiments can be considered as assigning the segment identifiers (IDs in this example) thereto. In the case where the IDs are used as the segment identifiers, the sizes of the respective segments have not to be constant and fixed. Anything used for identifying the respective segments in addition to the IDs may be called segment identifiers.

The step of reading the segment identifiers may be performed after decrypting the segments encrypted and stored in step 409 or after receiving the segments in step 406, depending on the embodiments. However, it is apparent that the step of reading the segment identifiers should be performed before generating the streaming data from the segments in step 410.

The streaming data generated in step 410 are provided to the player program in step 411, and the player program plays the streaming data.

The multimedia data playing method 400 is different from the prior art in that the streaming service is provided by the client computer rather than the server. However, since the streaming service is provided in common with each other, certain pieces of the multimedia data can begin to be played before the multimedia data are completely transmitted and the next pieces of multimedia data in play order can be received during the play is performed. In the conventional streaming service, if the transmission rate is slower than the play rate, a phenomenon that an audio or video cannot be smoothly played may occur. Therefore, according to a still further embodiment of the present invention for solving the problem, the multimedia data playing method further comprises the step of, during play of the streaming data generated from the segments, predicting and beforehand receiving segments necessary for the next play (step 413). The prediction of the segments necessary for the next play can be achieved in consideration of a play position, a play rate, a transmission rate, and the like. According to one embodiment of the present invention, the play order can be predicted using a CODEC that the player program utilizes so as to play the multimedia data and necessary segments can be predicted by calculating the segment identifiers. When the segments necessary for the play are predicted, the respective steps are performed again starting from step 402.

Further, the multimedia data playing method 400 may also comprise i) changing the position of the currently played segment upon receipt of the play position changing instructions and playing a segment at a changed position, and ii) when the streaming data are generated beyond a predetermined size, playing the streaming data by beginning to provide them to the player program, in the same manner as the multimedia data playing method 20 according to the first embodiment. Since such operations have been described in connection with the first embodiment, the detailed description thereof will be omitted in this embodiment.

Meanwhile, the present invention may provide a computer-readable recording medium in which a program for implementing the aforementioned various embodiments is recorded.

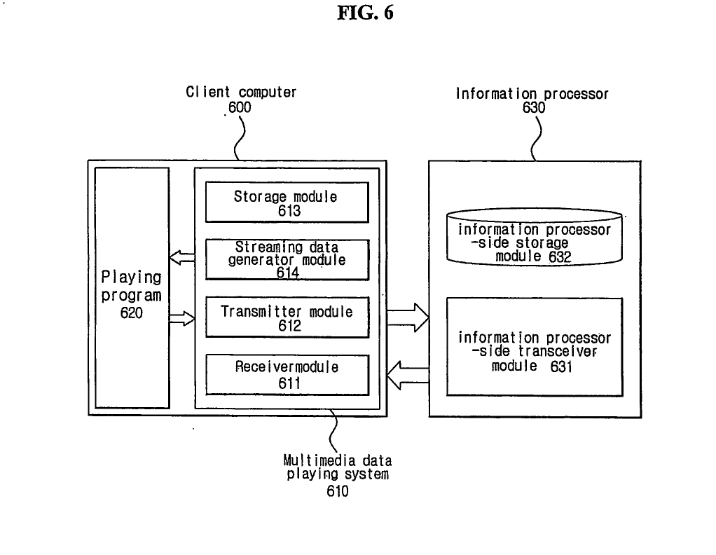

FIG. 6 is a system for playing multimedia data 610 according to a third embodiment of the present invention. The multimedia data playing system 610 comprises a transmitter module 611, a receiver module 612, a storage module 613, and a streaming data generator module 614. The multimedia data playing system 610 is installed in a client computer 600 in the same manner as a player program 620.

When play instructions are input from the player program 620 into the transmitter module 611 so as to play predetermined multimedia data, the transmitter module 611 transmits multimedia data requesting instructions for requesting the multimedia data. The multimedia data requesting instructions are received by an information processor-side transceiver module 631 of an information processor 630 (i.e., server or the other client computers) in which the multimedia data are stored. The information processor 630 transmits the multimedia data, which correspond to the multimedia data requesting instructions and are stored in an information processor-side storage module 632, to the multimedia data playing system 610. The receiver module 612 of the multimedia playing system 610 receives the multimedia data that are being transmitted. At this time, the multimedia data may be received using an arbitrary protocol in addition to the streaming protocol. This is because the multimedia data playing system 610 does not have to receive the multimedia data from the information processor 630 in accordance with the streaming method since the multimedia data playing system 610 is installed in the client computer 600 to provide the streaming service.

The storage module 613 stores the received multimedia data therein. The storage module 613 may have a kind of cache function by which multimedia data that have been previously requested at least once are stored therein and the multimedia data can be provided when they are requested by the player program 620 until they are expelled. In the conventional streaming service, the multimedia data are not stored in the client computer in which the multimedia data are played. As a result, if repeated play or return to an already played position is required, the data should be requested again to the server. Thus, standby time (buffering time) is needed for the play and a large load occurs in the server. In the present embodiment, since the data that have been received at least once are stored in the storage module with the cache function as described above, additional transmission and receipt of the data do not occur even though the repeated play or return to the already played position is required. Consequently, it is possible to eliminate the play standby time required for the receipt of the data and to reduce the load on the server. Meanwhile, a storage space of the storage module 613 may be varied or fixed in size, and a point of time when the multimedia data are expelled may be determined depending on applied schemes. That is, they may be changed according to users or requirements of fields employing them.

The streaming data generator module 614 generates the streaming data by using the stored multimedia data. Before the multimedia data to be played are fully transmitted, the streaming data generator module 614 can generate the streaming data by using the already received segments. That is, if there are generated streaming data sufficient to follow a play rate of the streaming data, the streaming data generator module 613 provides the already generated streaming data to the player program 620 to be played even before the remainder of the segments is fully transmitted. When the play is started after a certain amount of streaming data is generated, whether audios or videos are smoothly played is largely influenced by the transmission rate. That is, if the receiver module 612 receives the segments at a high rate, a rate at which the streaming data are generated is also increased. Thus, it is not necessary to wait until a too large amount of streaming data is initially generated. In a case where the streaming data are excessively generated before the play of the streaming data, it may take much time for the player program 620 to actually play the multimedia data from a point of time when the play instructions are input. Such a phenomenon may cause users who wish to play the multimedia data by using the player program 620 to be tedious. On the other hand, if the streaming data are not sufficiently generated up to a certain degree before start of the play, the users should wait for generation of the streaming data during the play. Thus, a pause state of the audios or videos (or a poor quality state due to improper play of the multimedia data) may be produced, whereby the users cannot properly enjoy the audios or videos. Therefore, the amount of the streaming data that should be generated by the streaming data generator module 614 before the start of the play will be set in consideration of the transmission rate and the like. According to a still further embodiment of the present invention, the amount of the streaming data that should be generated before the start of the play may be set by measuring the transmission rate between the client computer 600 and the information processor 630 whenever the input instructions are input.

Further, according to a still further embodiment of the present invention, in order to avoid occurrence of a state where the streaming data lacks because the generation rate of the streaming data becomes slower than the play rate thereof, the transmission rate of the segments from the information processor 630 can be increased and decreased by intermittently measuring the amount of already generated streaming data and the play rate, even after setting of the amount of the streaming data that should be generated before the start of the play. That is, if a sufficient amount of streaming data has been generated as compared with the play rate, the transmission rate of the segments from the information processor 630 to the client computer 600 is decreased so that a load on the information processor 630 for providing the segments can be reduced. If the amount of the streaming data lacks as compared with the play rate, the transmission rate of the segments from the information processor 630 to the client computer 600 is increased so that audios or videos of high quality can be provided to the users.

The player program 620 plays the streaming data provided by the streaming data generator module 614.

According to a still further embodiment of the present invention, the storage module 613 includes an encryption means 613a for encrypting and storing the multimedia data, and the streaming data generator module 614 includes a decryption means 614a for decrypting the encrypted multimedia data. Since the encryption means 613a and the decryption means 614a will be described in detail in connection with a fourth embodiment to be explained later, the detailed description thereof will be omitted in this embodiment.

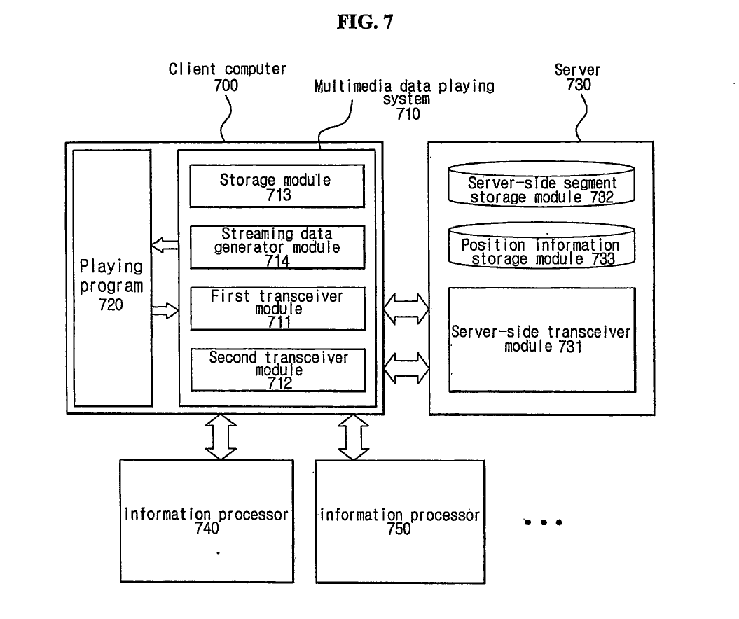

FIG. 7 shows a system for playing multimedia data 710 according to the fourth embodiment of the present invention. The multimedia data playing system 710 comprises a first transceiver module 711, a second transceiver module 712, a storage module 713, and a streaming data generator module 714. Contrary to the multimedia data playing system 610, the multimedia data playing system 710 is characterized in that the multimedia data are handled on a segment basis and the segments are received from a plurality of information processors including a server.

The first transceiver module 711 receives play instructions from a player program 720 and requests certain position information to a server 730. The position information is information for describing which information processors store segments of the multimedia data corresponding to the play instructions. The multimedia data playing system 710 receives the segments from the plurality of information processors. Thus, there is a need for the position information on the information processors in which the respective segments are stored. Since the examples, the preparing ways and the implementing algorithms according to the respective preparing ways of the position information have been described in detail in connection with the multimedia data playing method 600 according to the second embodiment, the detailed description thereof will be omitted in this embodiment.

In this embodiment, the server 730 comprises a server-side transceiver module 731 for transmitting and receiving the segments to and from the client computer 700, a position information storage module 733 for storing the position information and providing it upon receipt of a request for the position information from the first transceiver module 711, and a server-side segment storage module 732 for storing the segments. When the server-side transceiver storage module 731 receives the request for the position information from the first transceiver module 711, it selects relevant position information from the position information storage module 733 and then transmits the position information to the first transceiver module 711. When the first transceiver module 711 receives the position information, the second transceiver module 712 transmits segment requesting instructions for requesting the plurality of information processors to transmit relevant segments based on the position information, and receives the segments in parallel from the plurality of information processors. For example, in a case where based on the position information, segments 71 to 73 are received from the server 730, an information processor 740, and an information processor 750, respectively (it may be after the “inquiry” procedure described in connection with the second embodiment in order to determine information processors from which the respective segments are received), the second transceiver module 712 can receive segments 71 to 73 in parallel from the server 730 and the respective information processors 740, 750, as shown in FIG. 7. At this time, the segments transmitted from the server 730 and the information processors 740, 750 can be controlled by the second transceiver module not to overlap with one another. Therefore, in the case where the multimedia data are handled on a segment basis and received in parallel from the plurality of information processors in the same manner as this embodiment in order to receive the multimedia data, time duration required for transmission thereof can be greatly reduced as compared with a case where the multimedia data are received from a single information processor.

The segments received by the second transceiver module 712 are stored in the storage module 713. According to a still further embodiment of the present invention, the storage module 713 includes an encryption means 713a for encrypting and storing the received segments. In the case where the streaming service is provided using the multimedia data playing system 710 contrary to the conventional streaming service, since the multimedia data are stored in the client computer 700, there is a risk that the multimedia data may be duplicated to and drained out through the other client computers or other recording media. To avoid such a risk, the encryption means 713a is installed.

The streaming data generator module 714 generates the streaming data from the segments stored in the storage module 713. Meanwhile, in the case where the encryption means 713a is provided and the segments are encrypted and stored as described above, the streaming data generator module 714 includes a decryption means 714a for decrypting the encrypted segments.

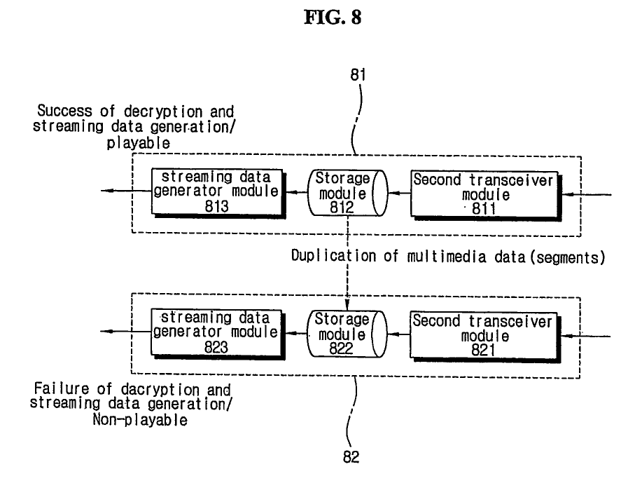

The aforementioned encryption and decryption processes will be described in detail with reference to FIG. 8. In a case where segments input from a second transceiver module 811 installed in a client computer 81 are encrypted by an encryption means 812a (not shown) and then stored in a storage module 812, a streaming data generator module 813 generates and provides the streaming data to the player program to be played after decryption of the encrypted segments by a decryption means 813a. If the encrypted segments are duplicated from the client computer 81 to a client computer 82 (specifically, storage module 822) with no agreement or the like of a rightful person, since the segments are in the encrypted and stored state, the streaming data cannot be normally generated by a streaming data generator module 823 and thus the play thereof cannot be properly achieved. Although the segments have been described in this embodiment, even in the case where not the segments but the multimedia data themselves are used in the same manner as the third embodiment, the steps of encryption→storage→decryption→generation of streaming data→play are directly applied to the multimedia data themselves.

Since specific configurations of the encryption means 713a and the decryption means 714a depart from the scope of the present invention and significantly need to be confidential, the detailed description thereof will be omitted herein. Further, according to a still further embodiment of the present invention, the encryption means 713a and the decryption means 714a are encryption and decryption means using conventionally known algorithms.

Additionally, according to a still further embodiment of the present invention, the streaming data generator module 714 includes a segment identifier reading means 714b for reading the segment identifiers to generate the streaming data based on the segment identifiers. The segment identifiers may be offsets of the respective segments or IDs assigned to the respective segments. The segment identifiers can allow the respective segments to be identified and simultaneously provide information on play order of the respective segments.

The segments that are transmitted in parallel (and optionally may have been encrypted) can be stored regardless of the play order thereof. At this time, when the segment identifier reading means 714b reads the segment identifiers of the respective segments, the streaming data generator module 714 can easily generate the steaming data by using the identification results.

Further, change of play positions can be easily made by provision of the segment identifier reading means 714b. If the play instructions for causing the multimedia data to be played have been input but the other instructions are not input, the streaming data generator module 714 generates the streaming data in accordance with the play order by using the segment identifiers read by the segment identifier reading means 714b. At this time, if the play position changing instructions for causing the multimedia data to be played at a position different from a position that is currently being played by the player program are input, the segment identifier reading means 714b reads a segment identifier of a segment corresponding to the changed position. Then, with the use of the read segment identifier, the streaming data can be generated in accordance with the play order starting from the segment corresponding to the changed position.

Meanwhile, respective components such as the streaming data generator module, the transceiver module and the segment identifier reading means described in the embodiments of the present invention have been classified according to their functions but may be implemented as the physically same apparatus or separate apparatuses.

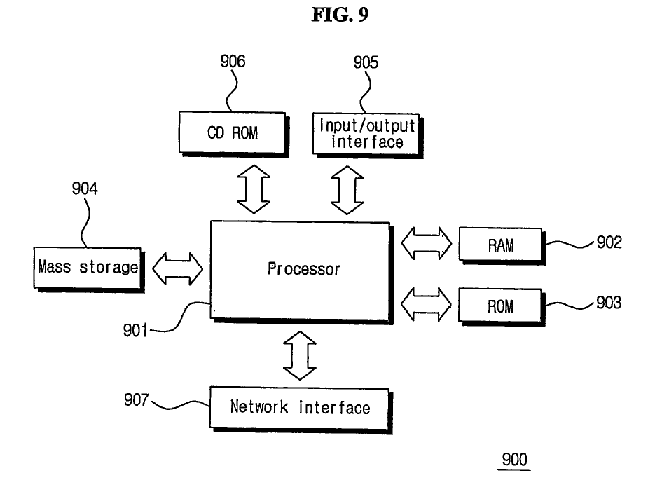

Hereinafter, a universal computer system that can be employed as the client computer for playing the multimedia data or the information processor for providing the multimedia data according to the present invention will be described. FIG. 9 is a block diagram showing an inner configuration of the computer system. The term “universal computer system” used herein intends to include any apparatuses in the form of set-top boxes comprising all or some of components shown in FIG. 9 as well as computers such as PCs.

The computer system 900 comprises at least one processor 901 connected with a main memory unit including a random access memory (RAM) 902 and a read only memory (ROM) 903. The processor 901 is also called a central processing unit (CPU). As well known in the art, the ROM 903 performs a function of unilaterally transmitting data and instructions to the CPU, and the RAM 902 is generally used for bilaterally transmitting data and instructions. The RAM 902 and the ROM 903 may include any proper types of computer-readable recording media. A mass storage 904 is bilaterally connected with the processor 901 to provide an additional data storage capability and may be any one of the computer-readable recording media. The mass storage 904 is used to store programs, data and the like, and is generally an auxiliary memory unit such as a hard disk slower than the main memory unit. A specific mass storage such as a CD ROM 906 may be used. The processor 901 is connected with at least one input/output interface 905 such as a video monitor, a track ball, a mouse, a keyboard, a microphone, a touch screen-type display, a card reader, a magnetic or paper tape reader, a speech or writing recognizer, a joystick or other known computer input/output devices. Finally, the processor 901 may be connected with a wire or wireless communication network through a network interface 907. The procedures of the method of the present invention can be performed through such a network. The aforementioned apparatuses and implements are well known to those skilled in the technical field of computer hardware and software.

The aforementioned hardware may be configured to operate as at least one software module for performing the operations of the present invention.

Although the present invention has been illustrated and described with reference to the exemplified embodiments and the drawings, the present invention is not limited thereto. It will be apparent that those skilled in the art to which the present invention pertains can make various changes and modifications thereto. Therefore, the present invention should be construed only based on the appended claims and equivalents thereof will fall within the scope of the present invention.

1. A method for playing multimedia data by receiving and then playing the multimedia data, comprising the steps of:
receiving play instructions from a player program;
requesting the multimedia data in response to the play instructions;
receiving and storing the multimedia data by using a protocol;
generating streaming data by using the stored multimedia data; and
causing the streaming data to be provided to and played by the player program.

2. The method as claimed in claim 1, wherein the multimedia data are divided into segments composing the multimedia data, and the steps are performed on a segment basis.

3. The method as claimed in claim 1, wherein the step of requesting the multimedia data comprises the step of requesting the multimedia data to a server or other client computers that have the multimedia data stored therein and are connected through a network to a client computer on which the player program is running.

4. The method as claimed in claim 3, further comprising the step of:
if the multimedia data are previously stored in the client computer, generating the streaming data from the stored multimedia data in response to the play instructions.

5. The method as claimed in claim 1, further comprising the steps of:
encrypting the received multimedia data before they are stored; and
decrypting the encrypted multimedia data before the streaming data are generated.

6. The method as claimed in claim 1, wherein the protocol is a protocol except a streaming protocol.

7. A method for playing multimedia data by receiving and then playing the multimedia data, comprising the steps of:
receiving play instructions from a player program;
receiving a plurality of segments composing the multimedia data from a plurality of information processors with the respective segments stored therein and storing the received segments, in response to the play instructions;
generating streaming data from the stored segments; and
causing the streaming data to be provided to and played by the player program.

8. The method as claimed in claim 2, wherein the play instructions include play position changing instructions for changing a position of a currently played segment and causing a segment at the changed position to be played.

9. The method as claimed in claim 1, wherein the step of causing the streaming data to be provided to and played by the player program comprises the step of, when the streaming data have been generated beyond a predetermined size, providing and playing the generated streaming data to and by the player program.

10. The method as claimed in claim 2, further comprising the step of reading segment identifiers of the segments, wherein the step of generating the streaming data from the stored segments is performed using the segment identifiers.

11. The method as claimed in claim 7, wherein the step of receiving the plurality of segments from the plurality of information processors with the segments stored therein and storing the received segments comprises the steps of:
receiving position information on the plurality of information processors with the respective segments stored therein from a predetermined server; and
receiving in parallel and storing the plurality of segments from the plurality of information processors based on the position information.

12. The method as claimed in claim 11, wherein the position information is information for describing information processors in which predetermined segments are stored, and
the step of receiving in parallel and storing the plurality of segments from the plurality of information processors based on the position information comprises the step of inquiring of the information processors described in the position information about whether the segments exist therein and receiving and storing the relevant segments from information processors which respond that the segments exist therein.

13. The method as claimed in claim 11, wherein the position information is information for describing information processors in which the segments composing the multimedia data are stored, and
the step of receiving in parallel and storing the plurality of segments from the plurality of information processors based on the position information comprises the step of inquiring of the information processors described in the position information about whether predetermined segments exist therein and receiving and storing the relevant segments from information processors which respond that the segments exist therein.

14. The method as claimed in claim 7, further comprising the steps of:
encrypting the received segments before they are stored; and
decrypting the encrypted segments before the streaming data are generated.

15. The method as claimed in claim 1, further comprising the step of predicting multimedia data necessary for play by measuring a play rate at which the streaming data are played by the player program.

16. A computer-readable recording medium in which a program for performing any one of the methods according to claim 1 is recorded.

17. A system for playing multimedia data by receiving and then playing the multimedia data, comprising:
a transmitter module for transmitting multimedia data requesting instructions for requesting the multimedia data when play instructions are input from a player program;
a receiver module for receiving multimedia data corresponding to the multimedia data requesting instructions from a server or other client computers by using a protocol;
a storage module for storing the multimedia data therein; and
a streaming data generator module for generating streaming data by using the stored multimedia data and providing the streaming data to the player program.

18. The system as claimed in claim 17, wherein the storage module includes an encryption module for encrypting and storing the multimedia data, and the streaming data generator module includes a decryption means for decrypting the encrypted multimedia data.

19. A system for playing multimedia data by receiving and then playing the multimedia data, comprising:
a first transceiver module for requesting position information on respective segments composing the multimedia data from a server in response to play instructions from a player program and receiving the position information from the server;
a second transceiver module for transmitting segment requesting instructions to a plurality of information processors based on the position information and receiving the segments in parallel from the plurality of information processors;
a storage module for storing the segments therein; and
a streaming data generator module for generating streaming data from the segments stored in the storage module and providing the streaming data to the player program.

20. The system as claimed in claim 19, wherein the streaming data generator module comprises a segment identifier reading means for reading segment identifiers of the segments to generate the streaming data based on the segment identifiers.

21. The system as claimed in claim 19, wherein the storage module includes an encryption means for encrypting and storing the segments, and the streaming data generator module includes a decryption means for decrypting the encrypted segments.

22. The system as claimed in claim 19, wherein the play instructions include play position changing instructions for changing a position of a currently played segment and causing a segment at the changed position to be played.
